(19) United States
(12) Patent Application Publication
(10) Pub. No.: US 2025/0313421 A1
(43) Pub. Date: Oct. 9, 2025

(54) DEVICE AND METHOD FOR PROVIDING A BOBBIN FOR A PRODUCTION MACHINE FOR THE ENERGY CELL-PRODUCING INDUSTRY, AND FACILITY FOR THE ENERGY CELL-PRODUCING INDUSTRY

(71) Applicant: KÖRBER TECHNOLOGIES GMBH, HAMBURG (DE)

(72) Inventors: Matthias HORN, AHRENSBURG (DE); Michael HAUL, KRÖPPELSHAGEN (DE); Arnd MEIER, BECKDORF (DE); Axel HENNING, OSTSTEINBECK (DE)

(21) Appl. No.: 18/862,830

(22) PCT Filed: Apr. 28, 2023
(86) PCT No.: PCT/EP2023/061202

§ 371 Date: Nov. 4, 2024

(30) Foreign Application Priority Data
May 6, 2022 (DE) 10 2022 111 360.4

(51) Int. Cl. B65H 19/12; H01M 4/74; H01M 10/04; H01M 50/403; H01M 50/44

(52) U.S. Cl. CPC B65H 19/12; H01M 10/0404; H01M 50/403; H01M 4/747; H01M 50/44

(57) ABSTRACT

The invention relates to a device for providing a bobbin with a wound web-type material for a production machine for the energy cell-producing industry, comprising: —at least one bobbin changing device and—a bobbin handling device which is designed to supply the bobbin to the at least one bobbin changing device, wherein—the bobbin changing device and the bobbin handling device are arranged in a common air conditioning chamber, and—a lock is provided which is designed such that the bobbin can be conveyed into the air conditioning chamber via the lock.

The present invention relates to a device for providing a bobbin with a wound-on material in web form for a production machine of the energy cell-producing industry according to the preamble of claim 1 and a corresponding method. The present invention also relates to a facility for the energy cell-producing industry.

Known in principle from the prior art is the use of energy cells or even energy storage devices in motor vehicles, other land vehicles, ships, aircraft or even in stationary systems such as, for example, photovoltaic systems, in the form of battery cells or fuel cells in which very large amounts of energy have to be stored over longer periods of time. For this purpose, such energy cells have a structure consisting of a plurality of segments stacked to form a stack. These segments are each formed from alternating anode sheets and cathode sheets, which are separated from one another by separator sheets that are also produced as segments. The segments are pre-cut in the production process and then placed on top of each other in the predetermined sequence to form the stacks and joined together by lamination.

The electrode sheets, i.e. the anode and cathode sheets, are usually formed from a so-called daughter coil, which in turn is formed from a mother coil. The mother coil comprises a finite, wound-on electrode web, wherein the width of this web is too large for forming a cell stack therefrom. For this reason, the mother coil is first unwound and cut lengthwise so that the width of the electrode web is reduced or several electrode webs of lesser width are formed. An electrode web cut in this way with a reduced width is then rewound as a so-called daughter coil. The daughter coil can then be unwound again in order to create segments therefrom by cutting it in the transverse direction, which segments are then suitable for forming a cell stack.

Even the segments in the form of separator sheets are formed from daughter coils by cutting the web running off the respective daughter coil in the transverse direction.

The production of the daughter coils usually takes place in a first production machine, which is spatially spaced apart from a second production machine for cutting and stacking the segments.

Coils are also commonly referred to as bobbins. The daughter coils described above can thus also be referred to as bobbins.

It is also known from the prior art that, in particular, the cutting into segments and their stacking takes place under predefined climatic conditions in order to reliably ensure a high quality of the cell stacks formed.

The object of the invention is to provide a device for providing a bobbin with a wound-on material in web form for a production machine of the energy cell-producing industry while complying with predefined climatic conditions, a corresponding method and a corresponding facility for the energy cell-producing industry.

The object is achieved by the features of the independent claims. Further preferred embodiments of the invention can be found in the dependent claims, the figures, and the associated description.

According to a first aspect of this application, the object is achieved by a device for providing a bobbin with a wound-on material in web form for a production machine of the energy cell-producing industry, comprising at least one bobbin changing device and a bobbin handling device which is designed to supply the at least one bobbin changing device with the bobbin, wherein the bobbin changing device and the bobbin handling device are arranged in a common air-conditioning chamber, wherein a lock is provided which is designed such that the bobbin can be conveyed into the air-conditioning chamber via said lock.

By means of the lock the exchange of air with the environment surrounding the air-conditioning chamber can be reduced when the bobbin is being introduced into the air-conditioning chamber, so that the climatic conditions in the air-conditioning chamber can be kept at a constant level. The material webs wound on the bobbins can thus be processed reliably.

The air-conditioning chamber preferably comprises an air-conditioning device for setting a predefined climate in the air-conditioning chamber. The air conditioning system can be used to set or regulate, for example, the room temperature, the relative humidity, the static pressure and/or the degree of air purity.

The bobbins can be brought into the air-conditioning chamber via the lock and positioned there in such a way that they can be reached and picked up by the bobbin handling device. The bobbin handling device then transfers the bobbin to at least one bobbin changing device.

The at least one bobbin changing device is preferably designed to rotatably support at least one bobbin so that its wound-on material web can be fed to a production machine of the energy cell-producing industry.

Preferably, a bobbin changing device comprises two receiving mandrels on each of which a bobbin can be rotatably supported. For example, a first receiving mandrel can hold a bobbin with a running-off material web and a second receiving mandrel can hold a new, unused bobbin. Shortly before the running-off material web has unwound completely, it can be connected to the material web on the unused bobbin; this is then referred to as splicing. Preferably, the used bobbin is then removed from the first receiving mandrel and from the air-conditioning chamber. This can likewise be done correspondingly via the lock. A new, unused bobbin can then be placed on the first receiving mandrel, which is then spliced to the material web on the second receiving mandrel now running off. By alternately supplying the first and second receiving mandrel with new, unused bobbins, the production machine can be reliably supplied with a corresponding material web, preferably even without interruption.

Preferably, the lock comprises a fluidically isolatable lock chamber through which the bobbin can be transported from an environment into the air-conditioning chamber. For example, the lock chamber can be hermetically sealed from the environment and the air-conditioning chamber. The lock chamber causes a reduced exchange of air volume between the air-conditioning chamber and the environment when a new bobbin is introduced into the air-conditioning chamber or when a used bobbin is removed from the air-conditioning chamber. The air-conditioning system must therefore provide less power to compensate for any deviations between the actual climate and the target climate. This can reduce the energy consumption of the air conditioning system.

Preferably, at least one lockable environment door is provided for connecting the lock chamber to the environment and at least one lockable climate chamber door is provided for connecting the lock chamber to the air-conditioning chamber. Further preferably, a control unit is provided which is designed to control the at least one environment door and the at least one climate chamber door such that only one of the doors can be opened at any one time. This prevents, for example, the simultaneous opening of a climate chamber door and an environment door; it also prevents, for example, the simultaneous opening of two environment doors or two climate chamber doors. By opening only one of the doors at a time, the air volume exchange between the air-conditioning chamber and the environment can be further reduced.

For example, there may be exactly one environment door and several climate chamber doors. Alternatively, for example, exactly one climate chamber door and several environment doors can be provided. Of course, it is also possible to provide several environment doors, for example exactly four, and several climate chamber doors, for example likewise exactly four.

According to a preferred embodiment, it is proposed that the bobbin handling device is designed to pick up the bobbin automatically, preferably fully automatically, and to transfer it to the at least one bobbin changing device. Preferably, the handling device is designed to receive the bobbins from a bobbin carrier. The bobbin handling device can comprise a sensor unit which is designed to detect the availability of a bobbin and its provision position. Furthermore, the bobbin handling device can comprise, for example, a robot arm which comprises a receptacle for holding the bobbin. Furthermore, the robot arm is configured to transfer the bobbin from a transfer position within the air-conditioning chamber to the at least one bobbin changing device. Since the bobbins are preferably brought into the air-conditioning chamber via the lock by means of a bobbin carrier in the form of a transport trolley, the bobbin handling device can also be referred to as a depalletizer. By automatically transferring the bobbin to the bobbin changing device, the exchange of air volume between the air-conditioning chamber and the environment can be further reduced because an additional air volume exchange that would occur when an operator enters the air-conditioning chamber can be prevented.

The bobbin handling device is preferably also designed to remove used bobbins, from which the material web has completely or almost completely run off, from the bobbin changing device and to transfer them to the said transfer position so that they can be brought from there by means of the bobbin carrier via the lock out of the air-conditioning chamber.

Preferably, a bobbin with a wound-on electrode web or separator web is mounted on at least one bobbin changing device. Further preferably, the bobbin is placed on a receiving mandrel on the bobbin changing device so that the bobbin is rotatably supported relative to the bobbin changing device. The electrode web can be an anode web or a cathode web.

Further preferably, the device comprises exactly four bobbin changing devices. A first bobbin changing device holds a bobbin with an anode web, a second bobbin changing device holds a bobbin with a cathode web, and a third and fourth bobbin changing device each hold a bobbin with a separator web. By means of the bobbin changing devices loaded in this way, the starting materials for the formation of a monocell can be provided for the production machine of the energy cell-producing industry.

A monocell consists of a first separator sheet, an anode sheet arranged thereon, a second separator sheet arranged thereon and a cathode sheet arranged thereon; the monocell can also have the following layer sequence: first separator sheet, cathode sheet arranged thereon, second separator sheet arranged thereon and anode sheet arranged thereon.

The four bobbin changing devices are preferably loaded with the said bobbins by a single common bobbin handling device. This means that additional bobbin changing devices are no longer necessary, which simplifies the overall design of the device.

According to a further preferred embodiment, the lock comprises several, preferably parallel, conveying paths via which the bobbins can be conveyed into the air-conditioning chamber. Further preferably, each of the conveying paths is assigned an environment door and a climate chamber door. The parallel arrangement of the conveyor paths allows the bobbin handling device to be supplied with different types of bobbins, for example with an anode web, cathode web or separator web, almost without delay. Furthermore, the conveyor paths each lead to their own, predefined transfer position, in which the bobbins are transferred to the bobbin handling device.

According to a second aspect of this application, the object is achieved by a facility for the energy cell-producing industry, wherein the facility comprises a device as described above and at least one production machine, wherein the at least one production machine is arranged completely or partially with the at least one bobbin changing device and the bobbin handling device in the air-conditioning chamber. Preferably, the production machine comprises a cutting device and, more preferably, additionally a cell stacking device. By means of the cutting device, the material web running off the bobbin can be cut in the transverse direction in order to form segments. By means of the cell stacking device, the segments can then be stacked on top of each other to form a cell stack. It goes without saying that the production machine can also comprise further processing units, for example a laminating device and/or a device for forming or attaching conductor lugs.

Since the production machine is at least partially located within the air-conditioning chamber, air exchange between the air-conditioning chamber and the environment can be further reduced.

According to a third aspect of this application, the object is achieved by a method for providing a material in web form wound on a bobbin for a production machine in the energy cell-producing industry, wherein the method is carried out using the device described above or using the facility described above. With regard to the technical effects and advantages associated with the method, reference is made to the previous explanations in connection with the device and the facility.

Preferably, at least one bobbin is held on a bobbin carrier in an environment of the air-conditioning chamber, wherein the bobbin carrier loaded with the at least one bobbin is transported via the lock from the environment into the air-conditioning chamber. Preferably, the bobbin carrier is movable, further preferably autonomously movable. The bobbin carrier preferably has a housing in which the one or more bobbins can be accommodated. The housing thus forms a transport chamber for the bobbins, which can be fluidically isolated from the environment. For example, the transport chamber can be hermetically sealed from its environment. The transport chamber can be loaded with the bobbins via at least one access door.

Preferably, in the interior of the transport chamber the bobbin carrier has at least one transport mandrel on which the bobbin can be held for transport. After loading, the at least one transport door is closed and the bobbin carrier is moved through the lock in this state. After passage through the lock, the access door within the air-conditioning chamber is opened and the bobbin is removed from the transport chamber, preferably by means of the bobbin handling device.

Further preferably, the bobbin carrier comprises two transport mandrels. For example, a new, unused bobbin can be brought via the lock into the air-conditioning chamber on a first transport mandrel, and a used bobbin can be brought out of the air-conditioning chamber via the lock into the environment on a second receiving mandrel. Alternatively, two new, unused bobbins can be transported into the air-conditioning chamber at the same time on the two transport mandrels of the bobbin carrier.

The invention is explained below using preferred embodiments with reference to the accompanying drawings. In the drawings:

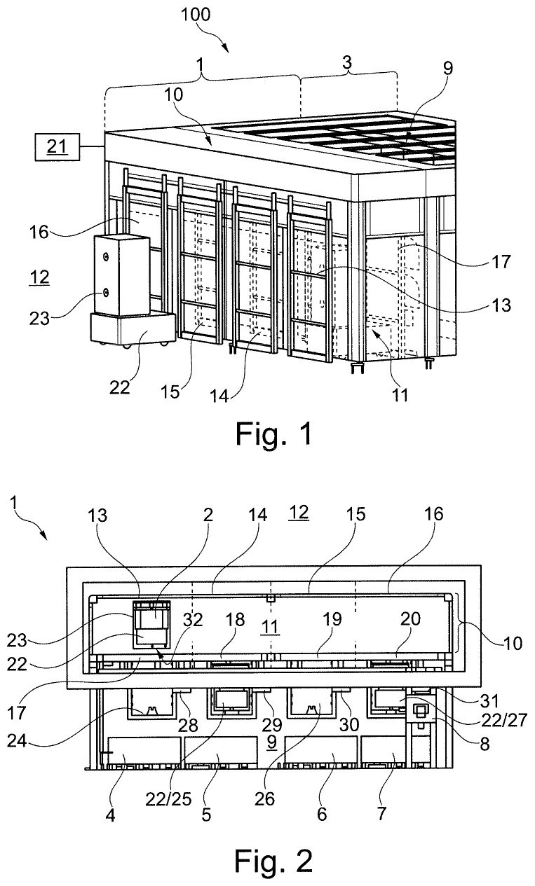

FIG. 1 shows a facility of the energy cell-producing industry in a perspective view; and

FIG. 2 shows a device for providing a bobbin for a production machine in the energy cell-producing industry in a sectional view from above.

FIG. 1 shows a facility 100 for producing cell stacks for the energy cell-producing industry. The facility 100 comprises a device 1 which serves to provide bobbins 2 with a wound-on material web (see FIG. 2) for a production machine 3, which is also part of the facility 100.

The device 1 comprises an air-conditioning chamber 9, in which the production machine 3 is also arranged so that the production of the cell stacks can take place under predefined climatic conditions. For this purpose, the air-conditioning chamber 9 comprises an air-conditioning device (not shown) by means of which the temperature, the relative humidity, the static pressure and/or the degree of purity of the air can be regulated.

In addition, a lock 10 is provided, via which a bobbin carrier 22 loaded with bobbins 2 (see FIG. 2) in the form of a movable transport vehicle can be brought into the air-conditioning chamber 9 from an environment 12 of the air-conditioning chamber 9. In the present exemplary embodiment, the bobbin carrier 22 is an autonomously movable, driverless transport vehicle.

The lock 10 comprises a lock chamber 11, which can be fluidically isolated not only from the environment 12 but also from the air-conditioning chamber 9. In addition, the lock 10 comprises four environment doors 13, 14, 15 and 16, through which the lock chamber 11 is accessible from the environment 12. Opposite the environment doors 13, 14, 15 and 16, four climate chamber doors 17, 18, 19 and 20 (see FIG. 2) are provided, via which the lock chamber 11 is connected to the air-conditioning chamber 9.

The bobbin carrier 22 shown in FIG. 1 is in a waiting position in front of the environment door 15. As soon as the environment door 15 opens, the bobbin carrier 22 moves into the lock chamber 11 and the environment door 15 closes again. Only when the environment door 15 is completely closed does the climate chamber door 19 arranged opposite the environment door 15 open (see FIG. 2) so that the bobbin carrier 22 can be moved into the air-conditioning chamber 9.

In addition, it can be seen in FIG. 1 that the bobbin carrier 22 comprises a housing 23 for forming a transport chamber in which the bobbin 2 can be transported while maintaining a microclimate. In this exemplary embodiment, the microclimate can be maintained by hermetically sealing against the environment the transport chamber formed by the housing 23. Due to the generally relatively short transport paths and transport times, active control and/or regulation of the climate within the transport chamber is not necessary. In principle, it is also possible to equip the bobbin carrier 22 with a mobile air-conditioning system.

The housing 23 of the bobbin carrier 22 comprises an access door 32 for loading and unloading the bobbin carrier 22 of the bobbin 2. The access door 32 is only opened when the bobbin carrier 22 has arrived in the air-conditioning chamber 9 and the corresponding air-conditioning chamber door 19 has been closed. Preferably, the loading of the bobbin carrier 22 with new, unused bobbins 2 also takes place within a further air-conditioning chamber, not shown.

For the mutually coordinated opening and closing of the environment doors 13, 14, 15, 16 and climate chamber doors 17, 18, 19, 20, the device 1 further comprises a control unit 21. This is designed to open only one of the doors 16-20 at a time, because this allows the air exchange between the environment 12 and the air-conditioning chamber 9 to be reduced.

The bobbins 2 brought into the air-conditioning chamber 9 through the lock 10 are then fed to the production machine 3 by means of a bobbin handling device 8 and by means of four bobbin changing devices 3-6 (cf. FIG. 2), which are also located within the air-conditioning chamber 9.

The production machine 3 comprises a cutting device (not shown) and a cell stacking device (also not shown). By means of the cutting device, the material webs unwound from the bobbins 2 can be cut in the transverse direction in order to form segments. Using the cell stacking device, the segments are then stacked on top of each other to form a cell stack. In this embodiment, the entire production machine 3 is arranged within the air-conditioning chamber 9.

FIG. 2 shows the device 1 in a sectional view from above. It can be seen that the arrangement of the environment doors 13-16 and of the climate chamber doors 17-20 in pairs opposite one another defines four parallel conveying paths of the lock 10.

It can also be seen that the bobbin handling device 8 and the four bobbin changing devices 4, 5, 6 and 7 are arranged within the air-conditioning chamber 9.

Between the environment door 13 and the climate chamber door 17, there is a first conveying path of the lock 10, which opens into a first transfer position 24, which is arranged within the air-conditioning chamber 9.

Between the environment door 14 and the climate chamber door 18, there is a second conveying path of the lock 10, which opens into a second transfer position 25, which is arranged within the air-conditioning chamber 9.

Between the environment door 15 and the climate chamber door 19, there is a third conveying path of the lock 10, which leads to a third transfer position 26, which is arranged within the air-conditioning chamber 9.

Between the environment door 16 and the climate chamber door 20, there is a fourth conveying path of the lock 10, which leads to a fourth transfer position 27, which is arranged within the air-conditioning chamber 9.

Furthermore, as shown here, each of the transfer positions 24, 25, 26 or 27 can be assigned an intermediate holding area 28, 28, 29 or 31 in which at least one bobbin 2 can be temporarily held.

The bobbin carrier 22 located in the lock chamber 11 in FIG. 2 is moved into the transfer position 24 once the climate chamber door 17 has been opened.

In this exemplary embodiment, the bobbin carrier 22 comprises two transport mandrels (not shown) for holding one bobbin 2 each. A new, unused bobbin 2 can be brought into the air-conditioning chamber 9 on a first transport mandrel. A second transport mandrel of the bobbin carrier 22 can be loaded with a used bobbin 2 in the air-conditioning chamber 9.

For example, a used bobbin 2 can be held in the holding area 28. As soon as the bobbin carrier 22 has arrived at the first transfer position 24 and the climate chamber door 17 has been closed and the transport chamber of the bobbin carrier 22 has been opened, the used bobbin 2 can be pushed by the handling device 8 from the intermediate storage 28 onto the empty transport mandrel of the bobbin carrier 22. The new, unused bobbin 2 can then be removed from the other transport mandrel of the bobbin carrier 22 by the handling device 8 and transferred to one of the bobbin changing devices 3-6.

Alternatively, the two transport mandrels can also be used to transport two bobbins 2 into the air-conditioning chamber 9 at the same time. In this case, the new, unused bobbins 2 can also be transported onward to one of the bobbin changing devices 4, 5, 6 or 7 via one of the intermediate holding areas 28, 29, 30 and/or 31.

In this exemplary embodiment, the bobbin changing device 4 is loaded with two bobbins 2, each comprising a wound-on cathode web; the bobbin changing device 4 is loaded with two bobbins 2, each comprising a wound-on anode web; the bobbin changing device 5 is loaded with two bobbins 2, each comprising a separator web; and the bobbin changing device 6 is loaded with two bobbins 2, each comprising a separator web. Of course, the bobbin changing devices 4 to 7 can also be arranged in an alternative sequence.

In this exemplary embodiment, each of the bobbin changing devices 4-7 comprises two receiving mandrels, namely a first receiving mandrel for a running-off bobbin 2 and a second receiving mandrel for a new, unused bobbin 2, so that the material web of an almost completely run-out bobbin 2 can be connected to the material web of a new, unused bobbin by splicing.

In this embodiment, the transfer positions 24-27 are each assigned to a specific type of bobbin 2. At the transfer position 24, only bobbins 2 with a wound-on cathode web are delivered; at the transfer position 25, only bobbins 2 with a wound-on anode web; and at the transfer positions 26 and 27, only bobbins 2 with wound-on separator webs. Of course, an alternative assignment of bobbin types to transfer positions 24-27 is also possible. The bobbins 2 provided at the transfer positions 24 to 27 are then transferred by the bobbin handling device 8 to the corresponding bobbin changing devices 4 to 7.

A used bobbin 2 can be transferred by means of the bobbin handling device 8 from the respective bobbin changing device 4, 5, 6 or 7 at one of the transfer positions 24, 25, 26 or 27 to the bobbin carrier 22 so that it can be disposed of via the lock 10.

In addition, the autonomously moving bobbin carriers 22 are controlled and/or regulated by a separate control unit or by the control unit 21 (shown in FIG. 1) in such a way that they only pass through the lock 10 when the respective transfer position 24, 25, 26 or 27 is also free. In this way, it can be ensured that the transfer positions 24-27 can be approached unhindered and an unnecessary opening of the lock chamber 11 is prevented.

The production machine 3 shown in FIG. 1 is supplied with the corresponding material webs via the bobbin changing devices 4-7 by unwinding them from the bobbins 2 rotatably supported in the bobbin changing devices 4-7.

### LIST OF REFERENCE SIGNS

1 Device
2 Bobbin
3 Production machine
4 Bobbin changing device
5 Bobbin changing device
6 Bobbin changing device
7 Bobbin changing device
8 Bobbin handling device
9 Climate chamber
10 Lock
11 Lock chamber
12 Environment
13 Environment door
14 Environment door
15 Environment door
16 Environment door
17 Climate chamber door
18 Climate chamber door
19 Climate chamber door
20 Climate chamber door
21 Control unit
22 Bobbin carrier
23 Housing
24 Transfer position
25 Transfer position
26 Transfer position
27 Transfer position
28 Intermediate storage
29 Intermediate storage
30 Intermediate storage
31 Intermediate storage
32 Access door
100 Facility

1. A device for providing a bobbin with a wound-on material in web form for a production machine for the energy cell-producing industry, comprising:
at least one bobbin changing device, and
a bobbin handling device which is configured to supply the at least one bobbin changing device with the bobbin, wherein
the bobbin changing device and the bobbin handling device are arranged in a common air-conditioning chamber, and wherein
a lock is provided which is configured such that the bobbin can be conveyed therethrough into the air-conditioning chamber.

2. The device according to claim 1, wherein
the lock comprises a fluidically isolatable lock chamber via which the bobbin can be conveyed from an environment into the air-conditioning chamber.

3. The device according to claim 2, wherein
at least one closable environment door is provided for connecting the lock chamber to the environment, and
at least one lockable climate chamber door is provided for connecting the lock chamber to the air-conditioning chamber.

4. The device according to claim 3, wherein
a control unit is provided which is configured to control the at least one environment door and the at least one climate chamber door such that only one of the doors is open at any one time.

5. The device according to claim 3, wherein
exactly one environment door and more than one climate chamber doors are provided.

6. The device according to claim 3, wherein
exactly one climate chamber door and more than one environment doors are provided.

7. The device according to claim 1, wherein
the bobbin handling device is configured to automatically pick up the bobbin and transfer it to the at least one bobbin changing device.

8. The device according to claim 1, wherein
a bobbin with a wound-on electrode web or separator web is held on at least one bobbin changing device.

9. The device according to claim 1, wherein
the lock comprises several conveying paths via which the bobbins can be conveyed into the air-conditioning chamber.

10. A facility for the energy cell-producing industry, wherein
the facility comprises a device according to claim 1, and at least one production machine, wherein
the at least one production machine is completely or partially arranged with the at least one bobbin changing device and the bobbin handling device in the air-conditioning chamber.

11. A method for providing a material in web form wound on a bobbin for a production machine of the energy cell-producing industry, wherein
the method is carried out using the device according to claim 1.

12. The method according to claim 11, wherein
at least one bobbin is held on a bobbin carrier in an environment of the air-conditioning chamber, and wherein
the bobbin carrier loaded with at least one bobbin is transported via the lock from the environment into the air-conditioning chamber.

13. The device according to claim 9, comprising parallel conveying paths.

14. A method for providing a material in web form wound on a bobbin for a production machine of the energy cell-producing industry, wherein the method is carried out in the facility according to claim 10.
